(19) United States
(12) Patent Application Publication
(10) Pub. No.: US 2026/0192193 A1
(43) Pub. Date: Jul. 9, 2026

(54) CLOUD GAMING TERMINAL DEVICE AND CLOUD GAMING SERVER AND METHODS FOR ADJUSTING ENCODER PARAMETERS BASED ON TERMINAL PLAYBACK QUALITY

(71) Applicant: Realtek Semiconductor Corp., HsinChu (TW)

(72) Inventors: Chien-Hung Cheng, HsinChu (TW); Chun-Ta Chen, HsinChu (TW); Po-Hsin Luo, HsinChu (TW)

(73) Assignee: Realtek Semiconductor Corp., HsinChu (TW)

(21) Appl. No.: 19/405,454

(22) Filed: Dec. 2, 2025

Related U.S. Application Data
(60) Provisional application No. 63/728,172, filed on Dec. 5, 2024.

(30) Foreign Application Priority Data
Nov. 21, 2025 (TW) 114145480

(51) Int. Cl. A63F 13/355; A63F 13/493

(52) U.S. Cl. CPC A63F 13/355; A63F 13/493

(57) ABSTRACT

A cloud gaming terminal device includes a playback quality evaluation unit and a feedback engine client. The playback quality evaluation unit is configured to generate at least one playback quality evaluation parameter based on information provided by at least one of a network interface control unit, a media decoding unit, and a media rendering unit within the cloud gaming terminal device. The feedback engine client is configured to transmit at least one playback quality evaluation parameter to a cloud gaming server through a network. The cloud gaming server is configured to adjust at least one media encoding parameter of a media stream according to the received playback quality evaluation parameter.

### CROSS REFERENCE TO RELATED APPLICATIONS

This application claims the benefit of U.S. Provisional Application No. 63/728,172, filed on Dec. 5, 2024. The content of the application is incorporated herein by reference.

### BACKGROUND OF THE INVENTION

### 1. FIELD OF THE INVENTION

The present invention relates to cloud gaming technology, and more particularly to a cloud gaming terminal device, cloud gaming server, and related methods for adjusting encoder parameters based on terminal playback quality.

### 2. DESCRIPTION OF THE PRIOR ART

In conventional audio-video streaming services, servers primarily adjust streaming parameters based on two aspects: hardware specifications of terminal devices (i.e., client devices) and network conditions. Hardware specifications include display capabilities such as maximum resolution, color depth, and high dynamic range supported by display devices, as well as computing capabilities of central processing units and graphics processing units of terminal devices. Regarding network conditions, servers can monitor current available bandwidth and dynamically adjust resolution and bit rate of video streams accordingly. However, this adjustment mechanism primarily focuses on continuity of streaming services rather than real-time performance.

Cloud gaming, as a special streaming application, has more stringent requirements for latency performance. Transmission control protocol (TCP) commonly adopted by conventional streaming services can ensure reliability of data transmission, but its data retransmission mechanism and large buffer design result in higher end-to-end latency, making it unsuitable for cloud gaming applications. Therefore, current cloud gaming services mostly adopt user datagram protocol (UDP) to transmit gaming streams. UDP lacks data retransmission mechanisms, which can reduce transmission latency, but cannot automatically recover data lost during transmission. More importantly, unidirectional transmission characteristics of UDP prevent servers from directly knowing the actual reception and playback status of terminal devices. This problem is particularly evident in wireless network environments, as Wi-Fi transmission is susceptible to environmental interference, potentially causing packet loss or delays, which can lead to video decoding errors, screen tearing, audio interruptions, and other issues that severely affect gaming experience.

Therefore, it can be understood that in UDP-based audio-video streaming applications, there is a lack of effective mechanism to collect and analyze actual playback quality information from terminal devices. The absence of real-time feedback mechanisms makes it difficult for cloud gaming services to maintain stable service quality in complex network environments.

### SUMMARY OF THE INVENTION

In view of this, the present invention provides a dynamic adjustment mechanism for encoder parameters based on playback quality of terminal devices (i.e., client devices). The present invention establishes a complete playback quality evaluation mechanism in cloud gaming terminal devices, which can real-time monitor and analyze transmission status of network interfaces, error events of media decoding units, and processing anomalies of media rendering units, thereby generating precise playback quality evaluation parameters. These parameters are transmitted to cloud gaming servers through specially designed feedback engine mechanisms to timely grasp actual playback conditions of terminal devices. Cloud gaming servers, based on these playback quality evaluation parameters and combined with intelligent algorithms, dynamically adjust key parameters of video encoders and audio encoders, thereby maintaining stable gaming experience under different network environments and client-side conditions. This innovative mechanism not only effectively improves the problem of unstable playback quality in conventional cloud gaming systems, but also provides reliable quality assurance for future real-time interactive multimedia applications.

According to one embodiment, a cloud gaming terminal device is provided. The cloud gaming terminal device comprises: a playback quality evaluation unit and a feedback engine client. The playback quality evaluation unit is configured to generate at least one playback quality evaluation parameter based on information provided by at least one of a network interface control unit, a media decoding unit, and a media rendering unit within the cloud gaming terminal device. The feedback engine client is configured to transmit the least one playback quality evaluation parameter to a cloud gaming server through a network. Specifically, the cloud gaming server adjusts at least one media encoding parameter of a media stream according to the received at least one playback quality evaluation parameter.

According to one embodiment, a cloud gaming server is provided. The cloud gaming server comprises a feedback engine server, an encoder parameter calculation unit, and a media encoding unit. The feedback engine server is configured to receive at least one playback quality evaluation parameter transmitted by a cloud gaming terminal device through a network. The encoder parameter calculation unit is configured to adjust at least one media encoding parameter according to the at least one playback quality evaluation parameter. The media encoding unit is configured to generate a media stream for providing to the cloud gaming terminal device according to the adjusted at least one media encoding parameter.

According to one embodiment, a method for a cloud gaming system is provided. The method comprises: generating at least one playback quality evaluation parameter based on information provided by at least one of a network interface control unit, a media decoding unit, and a media rendering unit of a cloud gaming terminal device; transmitting the at least one playback quality evaluation parameter to a cloud gaming server through a network; and adjusting at least one media encoding parameter of a media stream generated by the cloud gaming server according to the received at least one playback quality evaluation parameter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a cloud gaming system according to an embodiment of the present invention.

FIG. 2 is a schematic diagram of a cloud gaming system according to another embodiment of the present invention.

FIG. 3 is a schematic diagram of a cloud gaming server and terminal device according to an embodiment of the present invention.

FIG. 4 is a flowchart of a method for a cloud gaming system according to an embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment”, “an embodiment” or “some embodiments” means that a particular feature, structure or characteristic described in connection with the embodiment or example is included in at least one embodiment of the present embodiments. Thus, appearances of the phrases “in one embodiment”, “in an embodiment” or “in some embodiments” in various places throughout this specification are not necessarily all referring to the same embodiment(s). Furthermore, the particular features, structures or characteristics may be combined in any suitable combinations and/or sub-combinations in one or more embodiments.

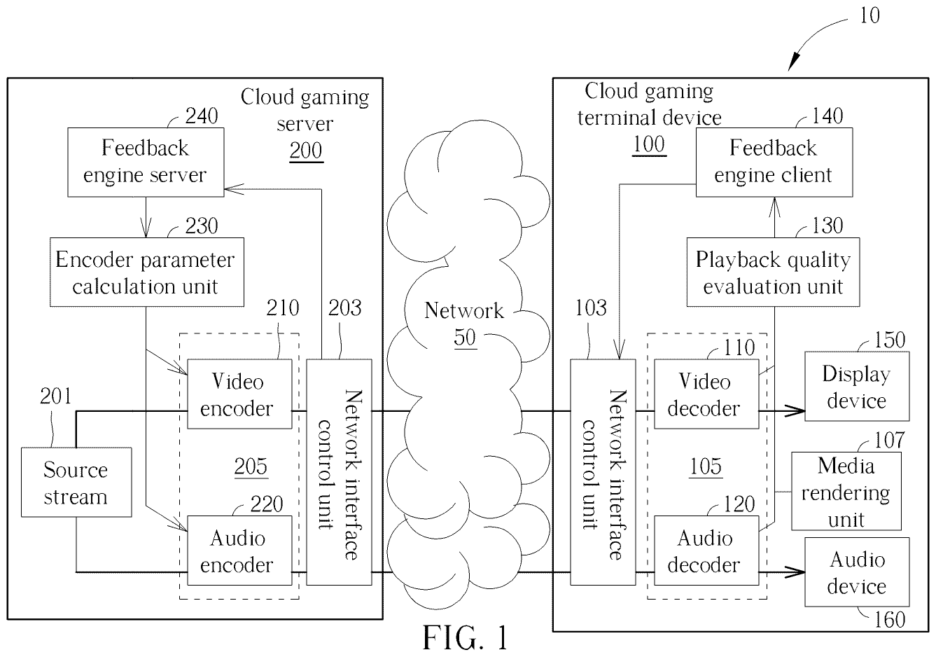

Please refer to FIG. 1, which illustrates a schematic diagram of a cloud gaming system according to an embodiment of the present invention. As shown, a cloud gaming system 10 includes a cloud gaming terminal device (i.e., client device) 100 and a cloud gaming server 200. The cloud gaming system 10 provides gaming computing architecture capable of achieving high-performance and low-latency gaming experience. The cloud gaming server 200 is primarily configured to execute game engine computations and game logic processing, including but not limited to physics computations, artificial intelligence computations, scene rendering, sound processing, and other complex computational tasks.

On the other hand, the cloud gaming terminal device 100 is primarily configured to establish bidirectional real-time communication links with the cloud gaming server 200 through a network 50. The network 50 may include network transmission links composed of network client devices, internet service provider equipment, and cloud service provider network equipment, ensuring real-time transmission of gaming data. In various embodiments of the present invention, the cloud gaming terminal device 100 may be various terminal devices with network connection capabilities such as game consoles, personal computers, laptop computers, tablet computers, smartphones, smart TVs, automotive entertainment systems, virtual reality head-mounted displays, etc.

The cloud gaming terminal device 100 includes: a network interface control unit 103, a media decoding unit 105 (including a video decoder 110 and an audio decoder 120), a media rendering unit 107, a playback quality evaluation unit 130, and a feedback engine client 140. The network interface control unit 103 is configured to receive a media stream provided by the cloud gaming server 200 through the network 50, wherein the media stream includes at least one video stream and at least one audio stream.

The video decoder 110 in the media decoding unit 105 is configured to decode the video stream to obtain decoded raw video frame sequences. The video decoder 110 may adopt hardware acceleration architecture and support multi-threaded decoding. In various embodiments of the present invention, the video decoder 110 supports multiple video encoding standards including but not limited to H.264/Advanced Video Coding (AVC), H.265/High Efficiency Video Coding (HEVC), VP9, AV1, and so on.

The audio decoder 120 in the media decoding unit 105 is configured to decode the audio stream provided by the cloud gaming server 200 to obtain raw audio data in pulse code modulation (PCM) format. The audio decoder 120 can support multi-channel audio processing and support complex audio streams including spatial audio effects. In various embodiments of the present invention, the audio decoder 120 supports multiple audio encoding standards such as: Advanced Audio Coding (AAC), MP3 (MPEG-1/2 Audio Layer III), AC3 (Dolby Digital), and so on.

Furthermore, the video stream and the audio stream are encapsulated in media streams using standardized multimedia container formats (such as: MPEG-TS, WebM, MP4, RTP, etc.), which provide necessary synchronization information and metadata to ensure synchronized transmission and playback of audio and video. The cloud gaming terminal device 100 can separate and extract video streams and audio streams through de-multiplexing operation on the media stream for subsequent decoding processing.

The media rendering unit 107 is configured to perform rendering processing on raw video frame sequences generated by the video decoder 110 and raw audio data generated by the audio decoder 120, outputting video display signals and audio playback signals that meet specifications of a display device 150 (e.g., a TV or a monitor) and an audio device 160 (e.g., an audio system). The display device 150 and the audio device 160 can adopt two configuration modes: built-in integration or external expansion. In built-in integration mode, these devices are directly integrated into the hardware system of the cloud gaming terminal device 100; in external expansion mode, these devices are connected to the cloud gaming terminal device 100 through standardized interfaces to provide users with complete gaming interactive experience.

The playback quality evaluation unit 130 can generate at least one playback quality evaluation parameter based on information provided by at least one of the network interface control unit 103, the media decoding unit 105, and the media rendering unit 107. In one embodiment, the playback quality evaluation unit 130 is configured to determine a playback quality evaluation parameter associated with at least one of a network delay time and a network packet loss rate based on information provided by the network interface control unit 103, such as packet delay time or packet continuity. This enables the playback quality evaluation unit 130 to reflect anomalies such as excessively high network delay time or excessively high network packet loss rate in the playback quality evaluation parameter.

In one embodiment, the playback quality evaluation unit 130 is configured to determine a playback quality evaluation parameter associated with a video decoding error based on information provided by the video decoder 110. For example, when the video decoder 110 detects error blocks during decoding (which may produce visual anomalies such as mosaics or tearing in video frames), the video decoder 110 can report this to the playback quality evaluation unit 130, enabling the playback quality evaluation unit 130 to reflect video decoding errors in the playback quality evaluation parameter. Alternatively, when the video decoder 110 detects errors or discontinuities in transmission sequence numbers of packets to be decoded, or errors or discontinuities in presentation timestamps of video frames during decoding, he video decoder 110 can report this to the playback quality evaluation unit 130, thereby reflecting video decoding errors in the playback quality evaluation parameter.

In one embodiment, the playback quality evaluation unit 130 is configured to determine a playback quality evaluation parameter associated with an audio decoding error based on information provided by the audio decoder 120. For example, when the audio decoder 120 detects insufficient data to be decoded in the buffer during decoding (which may cause audio interruption or distortion), the audio decoder 120 can report this to the playback quality evaluation unit 130, enabling the playback quality evaluation unit 130 to reflect audio decoding errors in the playback quality evaluation parameter.

In one embodiment, the playback quality evaluation unit 130 is configured to determine a playback quality evaluation parameter associated with an abnormal rendering state based on information provided by the media rendering unit 107. For example, when the media rendering unit 107 detects insufficient quantity of video frames to be rendered in the buffer during rendering processing (which may cause repeated frames or dropped frames), the media rendering unit 107 can report this to the playback quality evaluation unit 130, enabling the playback quality evaluation unit 130 to reflect the abnormal rendering state in the playback quality evaluation parameter. Alternatively, when the media rendering unit 107 detects that frame numbers or presentation timestamps of video frames are inconsistent with expected display timing during rendering processing, the media rendering unit 107 can report this to playback quality evaluation unit 130, thereby reflecting the abnormal rendering state in the playback quality evaluation parameter.

After the above operations are completed, the playback quality evaluation unit 130 delivers the generated at least one playback quality evaluation parameter to the feedback engine client 140 for transmission back to the cloud gaming server 200 through the network 50.

On the other hand, the cloud gaming server 200 includes a network interface control unit 203, a media encoding unit 205 (including a video encoder 210 and an audio encoder 220), an encoder parameter calculation unit 230, and a feedback engine server 240. The video encoder 210 is configured to perform video encoding on a source stream 201 to generate a video stream. The source stream 201 represents visual content of a game application and may originate from various sources. For example, the source stream 201 can be a real-time graphical output from the game application executing on the cloud gaming server 200. Alternatively, the source stream 201 could be a video feed received from an external device via a hardware input interface, such as a High Definition Multimedia Interface (HDMI) capture card, or an existing digital video stream after transcoding. The audio encoder 220 is configured to perform audio encoding on the source stream 201 to generate an audio stream. The video stream and the audio stream may be encapsulated in a media stream based on specific multimedia container formats and further transmitted to the cloud gaming terminal device 100 through the network interface control unit 203 via the network 50.

In one embodiment, the encoder parameter calculation unit 230 is configured to adjust at least one media encoding parameter according to the at least one playback quality evaluation parameter returned by the cloud gaming terminal device 100. Specifically, the feedback engine server 240 receives the at least one playback quality evaluation parameter returned by the feedback engine client 140 through the network interface control unit 203. Based on the at least one playback quality evaluation parameter, the encoder parameter calculation unit 230 dynamically adjusts at least one video encoder parameter used by the video encoder 210 and dynamically adjusts at least one audio encoder parameter used by the audio encoder 220.

In one embodiment, the at least one video encoding parameter includes at least one of group of pictures (GOP) length parameter, force instantaneous decoder refresh (IDR) frame insertion parameter, bitrate parameter, frame rate parameter, and resolution parameter. Specifically, when the at least one playback quality evaluation parameter returned by the cloud gaming terminal device 100 reflects high latency or playback errors (such as: excessively high network delay time, excessively high network packet loss rate, occurrence of video decoding errors and/or abnormal rendering state), at least one of the GOP length parameter, the force IDR frame insertion parameter, the bitrate parameter, the frame rate parameter, and the resolution parameter will be correspondingly adjusted.

In one embodiment, if high latency or playback errors occur, the GOP length parameter is dynamically adjusted. For instance, the GOP length may be shortened (e.g., from 300 to 100) in response to playback errors caused by packet loss, or lengthened to reduce the packet size to alleviate latency. In one embodiment, if high latency or playback errors occur, the force IDR frame insertion parameter will be set to enable the video encoder 210 to immediately insert decoder refresh frames in the video frame sequence, terminating inter-frame reference of video decoding. In one embodiment, if high latency or playback errors occur, the bitrate parameter will be adjusted to reduce the bit rate of the video stream (e.g., from 5-7 Mbps to 2-4 Mbps); conversely, the bitrate parameter will be adjusted to increase the bit rate of the video stream. In one embodiment, if high latency or playback errors occur, the frame rate parameter will be adjusted to reduce the frame rate of the video stream (e.g., from 60 fps to 30 fps); conversely, the frame rate parameter will be adjusted to increase the frame rate of the video stream. In one embodiment, if high latency or playback errors occur, the resolution parameter will be adjusted to reduce the resolution of the video stream (e.g., from 1080 p to 720 p); conversely, the resolution parameter will be adjusted to increase the resolution of the video stream.

In one embodiment, the at least one audio encoder parameter dynamically adjusted by the encoder parameter calculation unit 230 includes at least one of a channel number parameter, a bit rate parameter, and a sampling rate parameter. In one embodiment, if high latency or playback errors occur, the channel number parameter will be adjusted to reduce the number of channels (e.g., reducing from 5.1 channels to 2 channels); conversely, the channel number parameter will be adjusted to increase the number of channels. In one embodiment, if high latency or playback errors occur, the bit rate parameter will be adjusted to reduce the bit rate (e.g., reducing from 320 kbps to 192 kbps); conversely, the bit rate parameter will be adjusted to increase the bit rate. In one embodiment, if high latency or playback errors occur, the sampling rate parameter will be adjusted to reduce the sampling rate (reducing from 48 kHz to 44.1 kHz); conversely, the sampling rate parameter will be adjusted to increase the sampling rate.

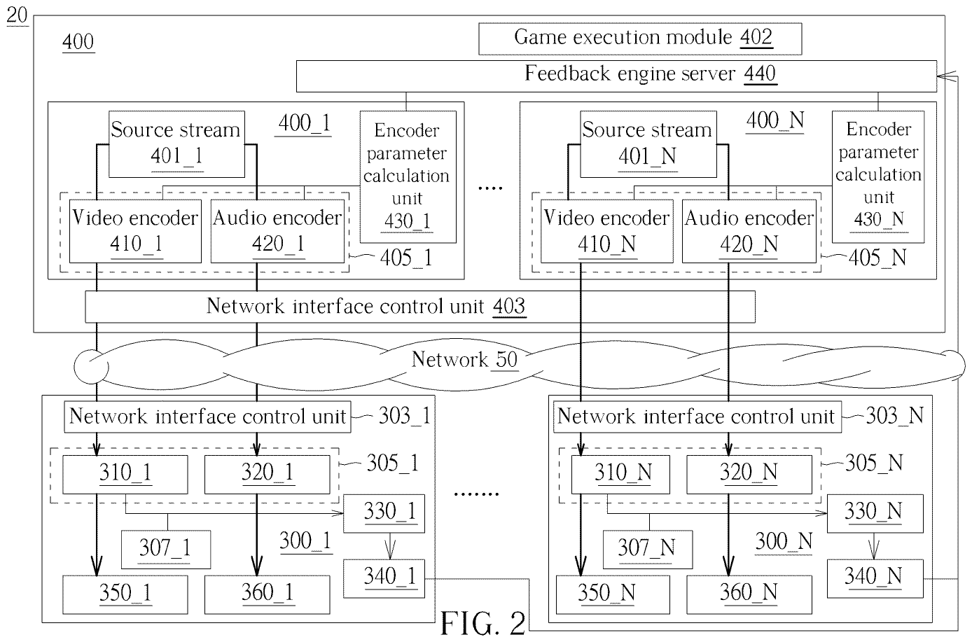

Please refer to FIG. 2, which illustrates a cloud gaming system according to another embodiment of the present invention. As shown, a cloud gaming system 20 has multiple cloud gaming terminal devices (i.e., client devices) 300_1-300_N and a cloud gaming server 400. The cloud gaming server 400 is configured to provide cloud gaming services to the cloud gaming terminal devices 300_1-300_N. The cloud gaming terminal devices 300_1-300_N primarily communicate with the cloud gaming server 400 through a network 50. The network 50 includes network transmission links composed of network client devices, internet service provider equipment, and cloud service provider network equipment. In different embodiments of the present invention, each of the cloud gaming terminal devices 300_1-300_N can be various terminal devices with network connection capabilities such as game consoles, personal computers, laptop computers, tablet computers, smartphones, smart TVs, automotive entertainment systems, virtual reality head-mounted displays, and so on.

Furthermore, each of the cloud gaming terminal devices 300_1-300_N respectively includes network interface control units 303_1-303_N, media decoding units 305_1-305_N (including video decoders 310_1-310_N and audio decoders 320_1-320_N), media rendering units 307_1-307_N, playback quality evaluation units 330_1-330_N, feedback engine clients 340_1-340_N, display devices 350_1-350_N, and audio devices 360_1-360_N. Since the cloud gaming terminal devices 300_1-300_N have similar architecture and operations to the above-mentioned cloud gaming terminal device 100, they will not be elaborated here for sake of brevity.

On the other hand, the cloud gaming server 400 includes multiple cloud gaming service modules 400_1-400_N, respectively configured to provide cloud gaming services to the cloud gaming terminal devices 300_1-300_N on a one-to-one basis (note that in some embodiments, the number of the cloud gaming service modules that cloud gaming server 400 can implement may be greater than the number of actually connected the cloud gaming terminal devices). Each of the cloud gaming service modules 400_1-400_N performs video and audio encoding on source streams 401_1-401_N through media encoders 405_1-405_N respectively, thereby generating corresponding video streams and audio streams, and provides them to corresponding cloud gaming terminal devices 300_1-300_N through the network interface control unit 403. A game execution module 402 in the cloud gaming server 400 executes specific game applications according to user selections provided by the cloud gaming terminal devices 300_1-300_N, thereby generating the source streams 401_1-401_N respectively corresponding to terminal devices, to provide corresponding game content to corresponding game service modules 400_1-400_N.

Furthermore, each of the cloud gaming terminal devices 300_1-300_N transmits at least one playback quality evaluation parameter generated by their respective playback quality evaluation units 330_1-330_N to a feedback engine server 440 of the cloud gaming server 400 via the network 50 through their respective feedback engine clients 340_1-340_N. The feedback engine server 440 receives playback quality evaluation parameters through the network interface control unit 403 and distributes them to corresponding ones of the cloud gaming service modules 400_1-400_M.

Encoder parameter calculation units 430_1-430_N in the cloud gaming service modules 400_1-400_M respectively adjust at least one video encoder parameter used by video encoders 410_1-410_N and/or adjust at least one audio encoder parameter used by audio encoders 420_1-420_N according to the above-mentioned approaches, based on at least one playback quality evaluation parameter provided by one of their corresponding cloud gaming terminal devices 300_1-300_N.

It is worth noting that the playback quality evaluation and feedback mechanisms, as well as encoder parameter adjustment mechanisms provided by the present invention, are not only applicable to cloud gaming systems. In other embodiments of the present invention, these mechanisms can also be applied to real-time multimedia streaming systems. For example, in live streaming platforms, terminal devices can return playback quality evaluation parameters to streaming source sides, enabling encoders to dynamically adjust encoding parameters of streams; or in multimedia projection systems under local area network environments, receiving devices can provide real-time playback quality feedback to projection source devices through the same mechanism, thereby achieving encoding adjustment of streams and ensuring optimal user viewing experience.

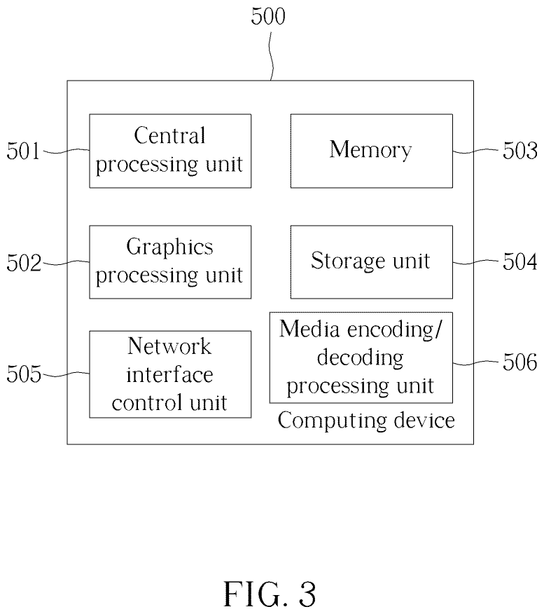

FIG. 3 illustrates a schematic diagram of a computing device according to an embodiment of the present invention, which can be used to implement the aforementioned cloud gaming server and/or cloud gaming terminal device. As shown, the computing device 500 includes a central processing unit (CPU) 501, a graphics processing unit (GPU) 502, a memory 503, a storage unit 504, a network interface control unit 505, and a media encoding/decoding processing unit 506. The CPU 501 can be a processor based on x86-architecture ARM-architecture processor, or other general-purpose processors. In embodiments of cloud gaming servers, the CPU 501 is primarily configured to execute game engine computations, processing player inputs, controlling game logic, and coordinating operations of various functional modules. In embodiments of cloud gaming terminal devices, the CPU 501 is responsible for managing multimedia decoding processes, processing playback quality evaluation, and controlling feedback mechanism operations. The GPU 502 can be an independent graphics card or integrated display chip, supporting graphics application programming interfaces (APIs) such as OpenGL and DirectX. In embodiments of cloud gaming servers, the GPU 502 is primarily configured to execute real-time rendering computations of game scenes and support hardware-accelerated video encoding. In embodiments of cloud gaming terminal devices, the GPU 502 is configured to assist video decoding and image display processing. The memory 503 can be dynamic random access memory or other high-speed memory. In embodiments of cloud gaming servers, the memory 503 is configured to store game runtime status data, caching player input data, and providing buffers required for video encoding. In embodiments of cloud gaming terminal devices, the memory 503 is configured to store decoded video frames, audio data, and temporary data required for playback quality evaluation. The storage unit 504 can be solid-state drives, hard drives, or other non-volatile storage devices. In embodiments of cloud gaming servers, the storage unit 504 is configured to store game applications, player data, and system configuration data. In embodiments of cloud gaming terminal devices, the storage unit 504 is configured to store client applications, playback settings, and necessary system data. The network interface control unit 505 can be wired network interface cards or wireless network interface cards. In embodiments of cloud gaming servers, the network interface control unit 505 is configured to handle large numbers of concurrent player connections, transmitting media streams, and receiving quality evaluation parameters from terminal devices. In embodiments of cloud gaming terminal devices, the network interface control unit 505 is configured to receive media stream and returning playback quality evaluation parameters to servers.

Additionally, the aforementioned media encoding/decoding units can all be implemented in software, or implemented as hardware encoding/decoding circuits, for example, implemented with media encoding/decoding unit 506 in FIG. 3, which can be independent or integrated audio or video processing chips, or one or more functional modules implemented in software. Moreover, the playback quality evaluation unit, the feedback engine client, the feedback engine server, and the encoder parameter calculation unit can also be implemented in software or hardware circuits respectively according to requirements.

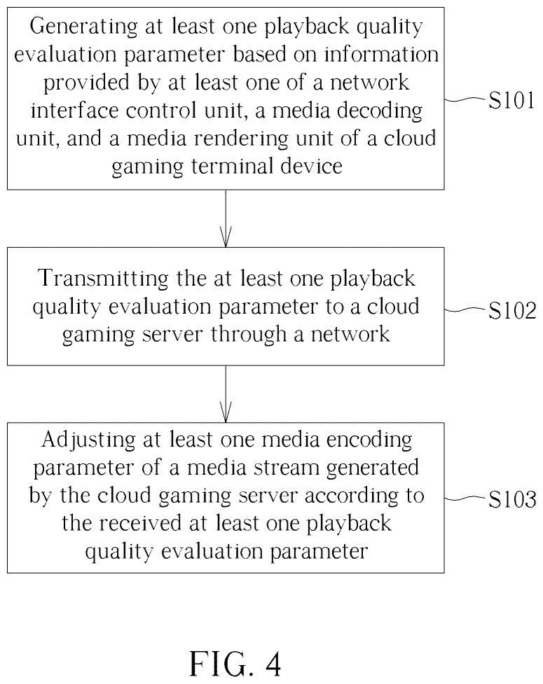

FIG. 4 illustrates a flowchart of a method for a cloud gaming system according to an embodiment of the present invention. As shown, the method includes following steps:
S101: generating at least one playback quality evaluation parameter based on information provided by at least one of a network interface control unit, a media decoding unit, and a media rendering unit of a cloud gaming terminal device;
S102: transmitting the at least one playback quality evaluation parameter to a cloud gaming server through a network; and
S103: adjusting at least one media encoding parameter of a media stream generated by the cloud gaming server according to the received at least one playback quality evaluation parameter.

Since principles and details of the above steps have been thoroughly explained through the above embodiments, they will not be repeated here. It is worth noting that the above flow can be improved for better cloud gaming service gaming experience through adding other additional steps or making appropriate modifications and adjustments.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cloud gaming terminal device, comprising:
a playback quality evaluation unit configured to generate at least one playback quality evaluation parameter based on information provided by at least one of a network interface control unit, a media decoding unit, and a media rendering unit within the cloud gaming terminal device;
a feedback engine client configured to transmit the at least one playback quality evaluation parameter to a cloud gaming server through a network;
wherein the cloud gaming server adjusts at least one media encoding parameter of a media stream according to the received at least one playback quality evaluation parameter.

2. The cloud gaming terminal device of claim 1, wherein the playback quality evaluation unit is configured to determine a playback quality evaluation parameter associated with at least one of a network delay time and a network packet loss rate based on information provided by the network interface control unit.

3. The cloud gaming terminal device of claim 1, wherein the playback quality evaluation unit is configured to determine a playback quality evaluation parameter associated with a video decoding error based on information provided by a video decoder in the media decoding unit.

4. The cloud gaming terminal device of claim 1, wherein the playback quality evaluation unit is configured to determine a playback quality evaluation parameter associated with an audio decoding error based on information provided by an audio decoder in the media decoding unit.

5. The cloud gaming terminal device of claim 1, wherein the playback quality evaluation unit is configured to determine a playback quality evaluation parameter associated with a abnormal rendering state based on information provided by the media rendering unit.

6. A cloud gaming server, comprising:
a feedback engine server configured to receive at least one playback quality evaluation parameter transmitted by a cloud gaming terminal device through a network;
an encoder parameter calculation unit configured to adjust at least one media encoding parameter according to the at least one playback quality evaluation parameter; and
a media encoding unit configured to generate a media stream for providing to the cloud gaming terminal device according to the adjusted at least one media encoding parameter.

7. The cloud gaming server of claim 6, wherein the encoder parameter calculation unit is configured to adjust at least one video encoding parameter according to the at least one playback quality evaluation parameter.

8. The cloud gaming server of claim 7, wherein the at least one video encoding parameter includes at least one of a group of pictures (GOP) length parameter, a force instantaneous decoder refresh (IDR) frame insertion parameter, a bitrate parameter, a frame rate parameter, and a resolution parameter.

9. The cloud gaming server of claim 6, wherein the encoder parameter calculation unit is configured to adjust at least one audio encoding parameter according to the at least one playback quality evaluation parameter.

10. The cloud gaming server of claim 9, wherein the at least one audio encoding parameter includes at least one of a channel number parameter, a bitrate parameter, and a sampling rate parameter.

11. A method for a cloud gaming system, comprising:
generating at least one playback quality evaluation parameter based on information provided by at least one of a network interface control unit, a media decoding unit, and a media rendering unit of a cloud gaming terminal device;
transmitting the at least one playback quality evaluation parameter to a cloud gaming server through a network; and
adjusting at least one media encoding parameter of a media stream generated by the cloud gaming server according to the received at least one playback quality evaluation parameter.

12. The method of claim 11, wherein the step of generating the at least one playback quality evaluation parameter comprises:
determining a playback quality evaluation parameter associated with at least one of a network delay time and a network packet loss rate based on information provided by the network interface control unit.

13. The method of claim 11, wherein the step of generating the at least one playback quality evaluation parameter comprises:
determining a playback quality evaluation parameter associated with a video decoding error based on information provided by a video decoder in the media decoding unit.

14. The method of claim 11, wherein the step of generating the at least one playback quality evaluation parameter comprises:
determining a playback quality evaluation parameter associated with an audio decoding error based on information provided by an audio decoder in the media decoding unit.

15. The method of claim 11, wherein the step of generating the at least one playback quality evaluation parameter comprises:
determining a playback quality evaluation parameter associated with a abnormal rendering state based on information provided by the media rendering unit.

16. The method of claim 11, wherein the step of adjusting the at least one media encoding parameter comprises:
adjusting at least one video encoding parameter according to the at least one playback quality evaluation parameter.

17. The method of claim 16, wherein the at least one video encoding parameter includes at least one of a group of pictures (GOP) length parameter, a force instantaneous decoder refresh (IDR) frame insertion parameter, a bitrate parameter, a frame rate parameter, and a resolution parameter.

18. The method of claim 11, wherein the step of adjusting the at least one media encoding parameter comprises:
adjusting at least one audio encoding parameter according to the at least one playback quality evaluation parameter.

19. The method of claim 18, wherein the at least one audio encoding parameter includes at least one of a channel number parameter, a bitrate parameter, and a sampling rate parameter.
